(19) United States
(12) Patent Application Publication
(10) Pub. No.: US 2024/0070010 A1
(43) Pub. Date: Feb. 29, 2024

(54) DEVICE AND METHOD FOR PROCESSING ABNORMAL SLEEP STATE OF OPERATING SYSTEM

(71) Applicant: Acer Incorporated, New Taipei City (TW)

(72) Inventors: Li-Ju LUO, New Taipei City (TW); Ling-Fan TSAO, New Taipei City (TW)

(73) Assignee: Acer Incorporated, New Taipei City (TW)

(21) Appl. No.: 18/205,960

(22) Filed: Jun. 5, 2023

(30) Foreign Application Priority Data
Aug. 24, 2022 (TW) 111131871

(51) Int. Cl. G06F 11/07; G06F 1/3296

(52) U.S. Cl. CPC G06F 11/079; G06F 1/3296; G06F 11/0793

(57) ABSTRACT

A device for processing an abnormal sleep state of an operating system is provided. The processing device includes a detection unit, an abnormal event determination unit, an event information verification unit and an abnormality notification unit. The detection unit detects whether a screen lid closing event occurs, wherein the operating system is preset to enter a sleep mode when a screen lid is closed, and the operating system is preset to enter a wake-up mode when the screen lid is opened. The abnormal event determination unit determines whether the screen lid is closed and whether an event that the operating system is not entering the sleep mode occurs. The event information verification unit verifies an event information and determines whether the event is classified as an abnormal event. The abnormality notification unit sends an abnormality notification to a system administrator unit, which performs a processing according to power status.

This application claims the benefit of Taiwan application Serial No. 111131871, filed Aug. 24, 2022, the subject matter of which is incorporated herein by reference.

### BACKGROUND OF THE INVENTION

### Field of the Invention

The invention relates in general to a processing device and a processing method for an operating system, and more particularly to a device and a method for processing an abnormal sleep state of an operating system.

### Description of the Related Art

When the screen lid and the main body are in a closed state, the operating system of a notebook computer normally is preset to enter a sleep mode. In the sleep mode, the requirement of power capacity is greatly reduced, the operating system is allowed to maintain its work state prior to the sleep mode, so that power can be saved, battery lifespan can be prolonged, and the operating system can be quickly recovered (enter a wake-up mode) to the work state from the sleep mode. Due to some abnormalities, the operating system may fail to enter the sleep mode even when the notebook is in a closed state. Such failure which is normally is unnoticed by the user may incapacitate the power-saving function, exhaust battery capacity, cause abnormal shutdown to the notebook computer, making the operating system unable to recover the work state before the sleep mode.

### SUMMARY OF THE INVENTION

The present invention is directed to a device and a method for processing an abnormal sleep state of an operating system. According to the present invention, a mechanism for reminding the user of an abnormal sleep state is created; when battery power capacity is lower than a certain power capacity, the current state of the operating system is recorded; when the operating system is restarted in the wake of abnormality, the work state is recovered with the screen shot data.

According to one embodiment of the present invention, a device for processing an abnormal sleep state of an operating system is provided. The processing device includes a detection unit, an abnormal event determination unit, an event information verification unit and an abnormality notification unit. The detection unit is used for detecting whether a screen lid closing event occurs, wherein the operating system is preset to enter a sleep mode when a screen lid is closed, and the operating system is preset to enter a wake-up mode when the screen lid is opened. The abnormal event determination unit is used for determining whether the screen lid is closed and whether an event that the operating system is not entering the sleep mode occurs. The event information verification unit is used for verifying an event information and determining whether the event is classified as an abnormal event according to the event information. The abnormality notification unit is used for sending an abnormality notification to a system administrator unit, which performs a processing according to the power status of the operating system.

According to one embodiment of the present invention, a method for processing an abnormal sleep state of an operating system is provided. The processing method includes the following steps. An operating system is enabled, and a system power is continuously provided, wherein the operating system is preset to enter a sleep mode when a screen lid is closed, and the operating system is preset to enter a wake-up mode when the screen lid is opened. Whether a screen lid closing event occurs is detected, and whether the screen lid is closed and whether an event that the operating system is not entering the sleep mode occurs is determined. An event information is verified, and whether the event is classified as an abnormal event according to the event information is determined. An abnormality notification is sent to a system administrator unit, which performs a processing according to the power status of the operating system.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A and 1B respectively are schematic diagrams of a device and a method for processing an abnormal sleep state of an operating system according to an embodiment of the present invention.

FIG. 2 is a detailed flowchart of a method for processing an abnormal sleep state of an operating system according to an embodiment of the present invention.

FIG. 3 is a flowchart of event information verification according to an embodiment of the present invention.

FIG. 4 is a detailed flowchart of a method for processing an abnormal sleep state of an operating system according to an embodiment of the present invention.

FIGS. 5A and 5B respectively are schematic diagrams of two reminder modes.

FIG. 6 is a schematic diagram of determining the remaining capacity to perform screen shot process.

FIG. 7 is a schematic diagram of a pre-defined table.

### DETAILED DESCRIPTION OF THE INVENTION

Technical solutions for the embodiments of the present application are clearly and thoroughly disclosed with accompanying drawings. Obviously, the embodiments disclosed below are only some rather than all of the embodiments of the present application. All embodiments obtained by anyone ordinarily skilled in the technology field of the present application according to the disclosed embodiments of the present application are within the scope of protection of the present invention if the obtained embodiments lack innovative labor. Similar/identical designations are used to indicate similar/identical elements.

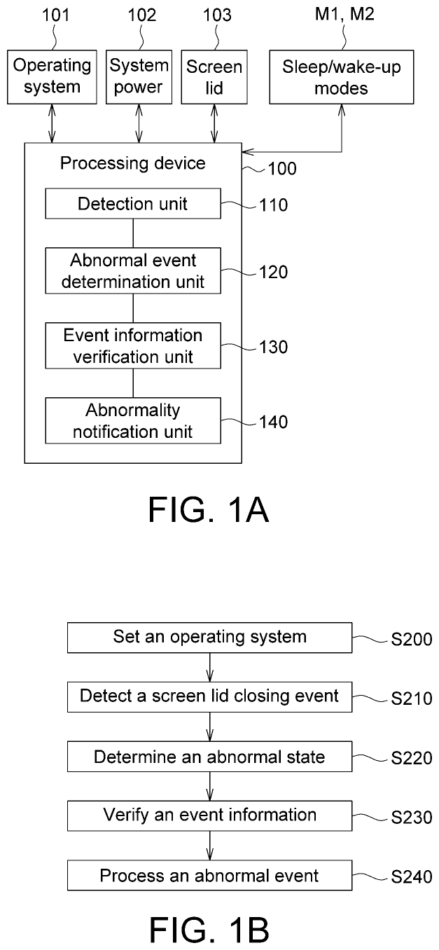

Referring to FIGS. 1A and 1B, respective schematic diagrams of a device and a method for processing an abnormal sleep state of an operating system 101 according to an embodiment of the present invention are shown.

The processing device 100 includes a detection unit 110, an abnormal event determination unit 120, an event information verification unit 130 and an abnormality notification unit 140. Each of the above units can be realized by such as a chip module, an integrated circuit, an application or a combination thereof. The processing method includes: setting an operating system (step S200), detecting a screen lid closing event (step S210), determining an abnormal state (step S220), verifying an event information (step S230) and processing an abnormal event (step S240). The functions and details steps of each unit are disclosed below.

In the present embodiment, the detection unit 110 is used for detecting whether a screen lid closing event occurs, wherein the operating system 101 is preset to enter a sleep mode M1 when a screen lid 103 is closed, and the operating system 101 is present to enter a wake-up mode M2 when the screen lid 103 is opened. The abnormal event determination unit 120 is used for determining whether the screen lid 103 is closed and an event of the operating system 101 not entering the sleep mode M1 occurs. The event information verification unit 130 is used for verifying an event information and determining whether the event is classified as an abnormal event according to the event information. The abnormality notification unit 140 is used for sending an abnormality notification to a system administrator unit, which performs a processing according to the power status of the operating system 101.

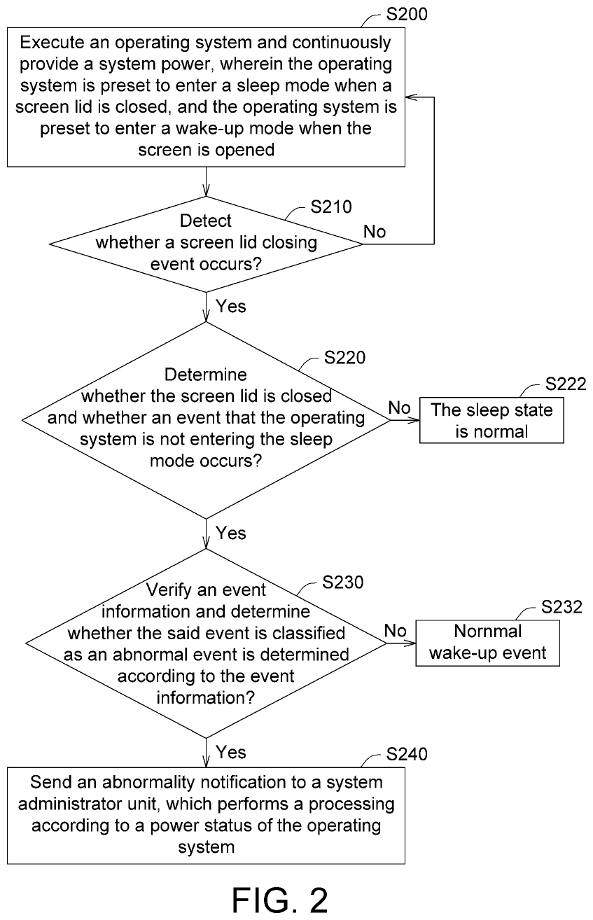

Referring to FIG. 2, a detailed flowchart of a method for processing an abnormal sleep state of an operating system 101 according to an embodiment of the present invention is shown. First, in step S200, an operating system 101 (such as Windows application) is executed and a system power 102 (such as a battery or an external power) is continuously provided, wherein the operating system 101 is preset to enter a sleep mode M1 (sleep mode is also referred as power-saving mode) when a screen lid 103 is closed, and the operating system 101 is preset to enter a wake-up mode M2 when the screen lid 103 is opened. In step S210, whether a screen lid 103 closing event occurs is detected. If the screen lid 103 closing event does not occur (for instance, the shaft of the notebook computer does not rotate over a preset angle), this indicates that the screen lid 103 is currently in use. Conversely, if the screen lid 103 closing event is detected (for instance, the shaft of the notebook computer rotates by more than 90°), this indicates that the screen lid 103 is not in use but is in a closed state.

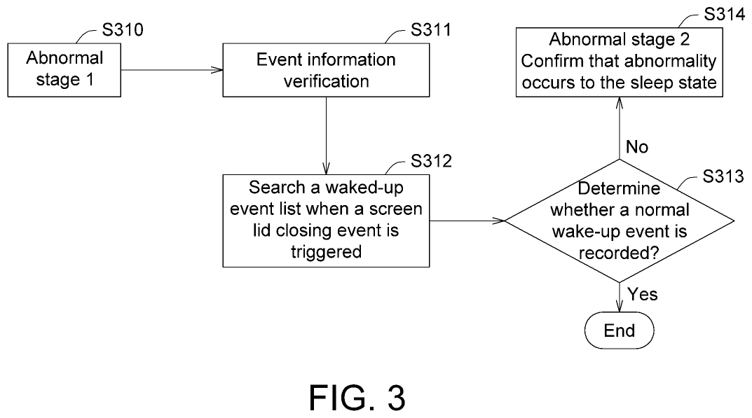

In step S220, whether the screen lid 103 is closed and an event of the operating system 101 not entering the sleep mode M1 occurs is determined. For instance, the shaft of the notebook computer rotates by more than 90° and the screen lid 103 is in a closed state, but the power of the operating system 101 is still in a power-on state. Meanwhile, the system power 102 is in a normal power consumption state, not in a power-saving state, such as S3 standby mode, S4 standby mode or modern standby mode. This indicates that the system power 102 is different from the preset power status (the operating system 101 is preset to enter a sleep mode M1). This stage initially confirms that abnormality occurs to the sleep state of the operating system 101 and the method proceeds to an abnormality stage 1 (referring to the step S310 of FIG. 3).

In step S230, an event information (referring to FIG. 3, a flowchart of event information verification is shown) is verified, and whether the said event is classified as an abnormal event is determined according to the event information. In the event information verification (referring to step S311), the event of the operating system 101 entering a sleep mode M1 as recorded in the system event detector is analyzed and verified. First, when the screen lid 103 closing event is triggered, the search of the event history begins with the event that the operating system is entering a sleep mode and ends at the first waked-up event, that is, when the screen lid 103 closing event is triggered, whether a normal wake-up event is recorded in a waked-up event list is determined (step S312 to S313). If a normal wake-up event is not recorded, then the method proceeds to an abnormal stage 2 (referring to the step S314 of FIG. 3), which indicates that abnormality occurs to the sleep state of the operating system 101. Conversely, if a normal wake-up event is recorded, this indicates that the sleep state of the operating system 101 is normal (referring to the step S222 of FIG. 2).

In an embodiment, when the user enables the operating system 101 through a remote waking-up function and the screen lid 103 of the notebook computer is in a closed state, by looking up the screen wake-up event in the record, it can be determined that this remote waking-up event is a normal wake-up event and will not be erroneously classified as an abnormal event (referring to of FIG. 2 the step S232), because the remote waking-up event is a normal wake-up event and is recorded by the system event detector.

In step S240, when an abnormal event occurs to the system, the abnormality notification unit 140 is used for sending an abnormality notification to a system administrator unit, which performs a processing according to the power status of the operating system 101. The abnormality notification can be divided into two parts. Part 1: the setting of the operating system 101 is adjusted, so that the power consumption of the operating system 101 is reduced (meanwhile, the remaining capacity is still at a high level); the setting allows the operating system 101 to recover the work state once the user opens the screen lid 103 again. Part 2: an abnormality notification is sent to the user, so that the user can take necessary response (meanwhile, the remaining capacity is low level). When power supply is in a poor condition, the abnormality notification will stop system operation to avoid system power being interrupted. The setting of abnormality notification can be selectively turned on or turned off by the user through a user interface, but the default setting is turned-on.

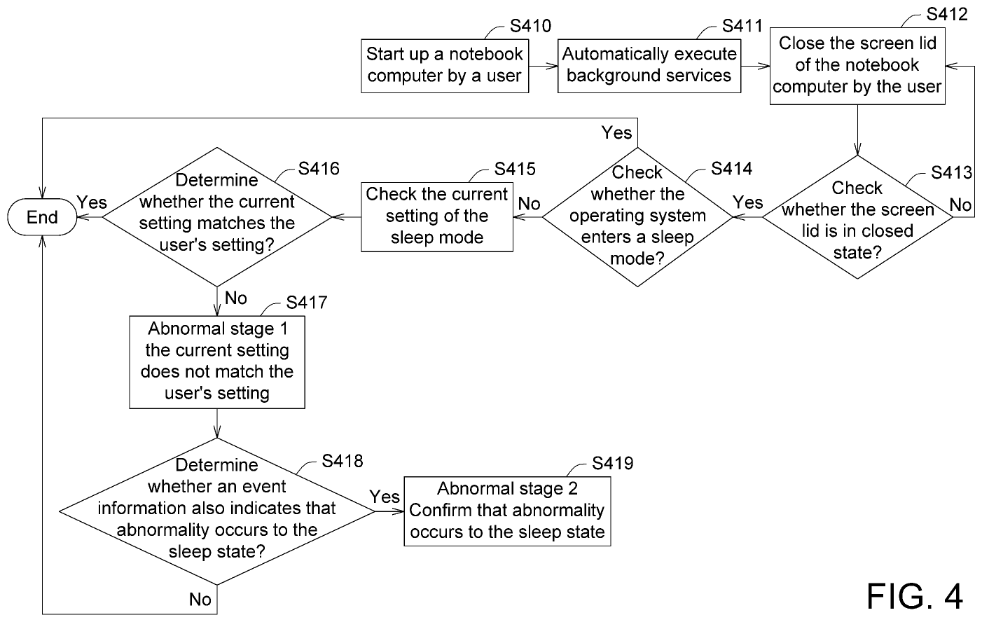

Referring to FIG. 4, a detailed flowchart of a method for processing an abnormal sleep state of an operating system 101 according to an embodiment of the present invention is shown. First, the user starts up the notebook computer (step S410). The background services of the operating system 101 are automatically executed (step S411). When the user closes the screen lid 103 of the notebook computer (step S412), the processing device 100 checks whether the screen lid 103 is in a closed state (step S413). If the screen lid 103 is in a closed state but the operating system 101 does not enter a sleep mode M1 (step S414), then the processing device 100 checks the setting of the sleep mode M1 (step S415) to determine whether the current setting matches the user's setting (step S416, i.e., whether the power status is in a power-saving mode is checked). If it is determined that the operating system is in abnormal stage 1 (step S417, the current setting does not match the user's setting), then the processing device 100 initially confirms that abnormality may occur to the sleep state of the operating system 101. Then, whether an event information also indicates that abnormality occurs to the sleep state is determined (step S418). If yes, it is determined that the operating system is in abnormal stage 2 (step S419), which indicates that abnormality occurs to the sleep state of the operating system 101.

When the system has an abnormal event, the abnormality notification unit 140 is used for sending an abnormality notification to a system administrator unit. Meanwhile, the system administrator unit can set the power planning option to a power-saving mode through a power plan control and an application interface (API). For instance, the setting of CPU is adjusted to 0%, the brightness of the screen is adjusted to 0%, and the power-saving feature of each element is enabled, or the function of each element is disabled. That is, by adjusting the settings of the operating system 101, the power consumption of the operating system 101 can be reduced.

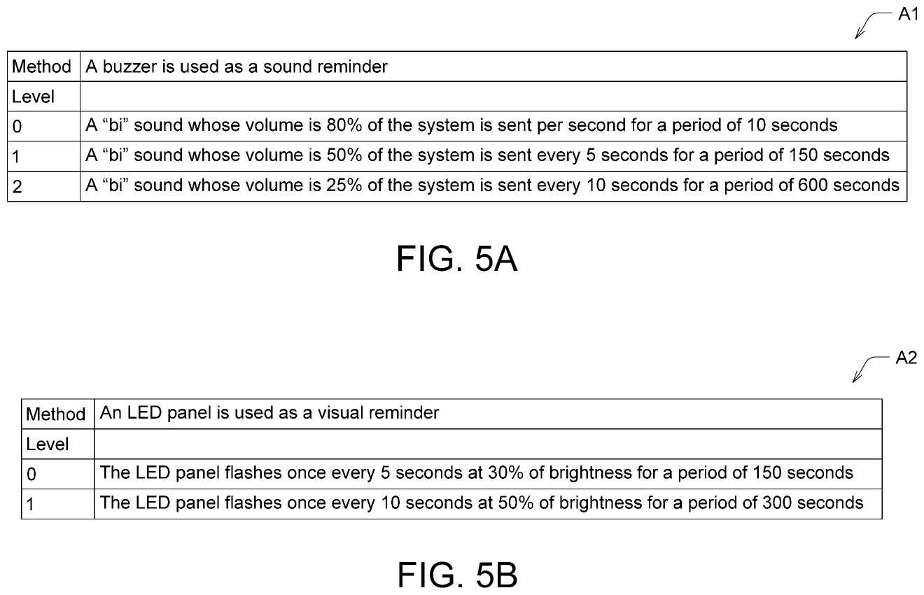

Referring to FIGS. 5A and 5B, schematic diagrams of two reminder modes are respectively shown, wherein the reminder modes A1 and A2 are used for sending an abnormality notification to the user, so that the user can take necessary response. In the present embodiment, the abnormality notification unit 140 can select most suitable method and level (and/or priority) to inform the user according to the conditions of judgement. The levels of each method (the smaller the number, the higher the level (i.e., top priority); higher levels are for emergent states) are illustrated in the table. When there are several methods suitable to be sent to inform the user, one or all of these suitable methods will be used.

As indicated in FIG. 5A, a buzzer is used as a sound reminder. The buzzer sends a “bi” sound at an interval of time; the more emergent the state, the louder the “bi” sound and the higher the frequency. For instance, at level 0, a “bi” sound whose volume is 80% of the system is sent per second for a period of 10 seconds; at level 1, a “bi” sound whose volume is 50% of the system is sent every 5 seconds for a period of 150 seconds; at level 2, a “bi” sound whose volume is 25% of the system is sent every 10 seconds for a period of 600 seconds.

For instance, the above conditions of judgement can be exemplified as follows: whether the device (e.g., a notebook computer) is moving and whether the remaining capacity is lower than a preset value (such as is lower than 10%). When one of the conditions is met, the buzzer is used as sound reminder. Whether the device is moving can be determined by periodically scanning the wireless AP in the surrounding environment and comparing the list of the multimedia access control address (MAC address) of wireless base stations. For instance, when the list of wireless AP obtained from the previous scanning differs with the list of wireless AP obtained from the current scanning by more than 50%, it can be determined that the device is moving. Besides, the processing device 100 can determine the level at which the buzzer is used as sound reminder according to the remaining capacity. For instance, when the remaining capacity is higher than 50%, the level is set to 2; when the remaining capacity is lower than 50%, the level is set to 1; when the remaining capacity is lower than 10%, the level is set to 0.

Since the volume of background sound influences the user's hearing, the processing device 100 detects the volume of background sound through the device microphone (MIC) then adjusts the volume of buzzer sound according to the volume of background sound. For instance, when the volume of background sound is greater than a preset value (such as 40 dB), the volume of buzzer sound is increased by 10%.

As indicated in FIG. 5B, an LED panel (i.e., a screen) is used as a visual reminder. The LED panel flashes or displays a light-and-dark frame at an interval of time; the more emergent the state, the higher the frequency. For instance, at level 0, the LED panel flashes once every 5 seconds at 30% of brightness for a period of 150 seconds; at level 1, the LED panel flashes once every 10 seconds at 50% of brightness for a period of 300 seconds.

The LED panel visual reminder is preset to be activated. When the user is moving with the device, normally the device is at the user's hand or is placed at a bag. Thus, the reminder sent by the LED panel is less likely to be detected by the user, and it is virtually a waste of power. Hence, once it is determined that the user is moving with the device, the LED visual reminder can be set to be non-activated.

Whether the device is moving can be determined according to the abovementioned method of scanning and listing the wireless AP of wireless base stations. Additionally, the processing device 100 can determined the level at which LED panel visual reminder is activated according to the remaining capacity. For instance, when the remaining capacity is higher than 50%, the level is set to 1; when the remaining capacity is lower than 50%, the level is set to 0.

On the other hand, when the abnormal sleep state of the system is confirmed and it is determined that the battery lifespan of the system power 102 is lower than a certain power capacity (for instance, the remaining battery lifespan is less than 1 hour), the processing device 100 can record the operating state of the system prior to the abnormal shutdown of the system then recover the system and execute the process according to the screen shot data when the device is started up next time.

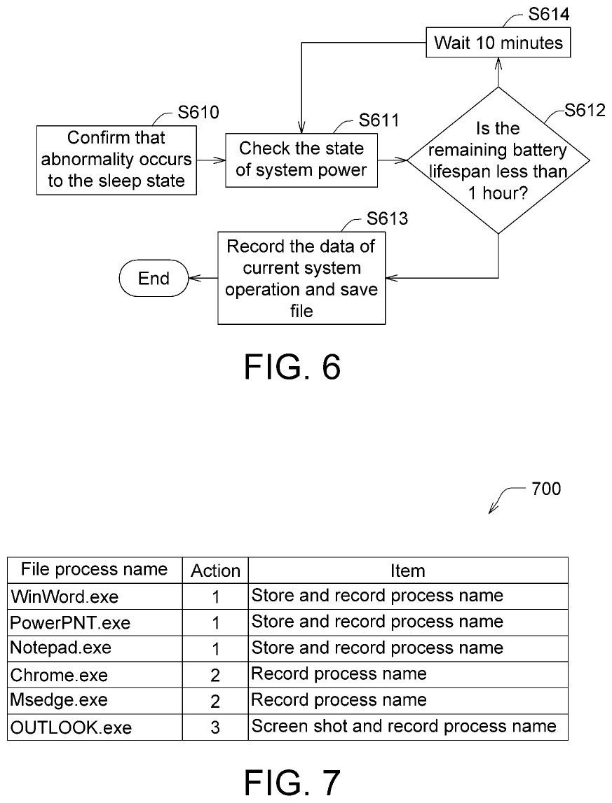

Referring to FIG. 6, a schematic diagram of determining the remaining capacity to perform screen shot process is shown. When the abnormal sleep state of the operating system 101 is confirmed (see step S610), the state of the system power 102 (such as battery) is checked (see step S611). Then, determination is made according to the remaining capacity (such as battery) and power consumption speed of the system power 102. If the remaining capacity of the system power 102 is lower than a certain power capacity (see step S612, for instance, the remaining battery lifespan is less than 1 hour), it is determined that the remaining capacity is too low, and a screen shot process needs to be executed (see step S613, the data of current system operation is recorded, and the file is saved). If the remaining capacity is greater than a certain power capacity, then a time interval (see step S614, the time interval is every 10 minutes) at which power consumption is calculated is set.

In an embodiment, the remaining capacity and the power consumption speed are calculated as follows. First, total power consumed by current system operation is calculated as follows: Wh=W(watt)*h(hour). Then, the total power (Wh) is divided by system voltage (V) as follows: load current (mA)=(WhN)/1000. Lastly, the remaining capacity (mAh) of the system power 102 is divided by load current (mA) to obtain the battery lifespan of the system power 102 (power consumption speed).

When the power capacity of the system power 102 is lower than 10%, system program may be interrupted or shutdown at any time. To avoid the data being lost or damaged, the processing device 100 can record the operating state of the system prior to the abnormal shutdown of the system. The processing procedure includes at least one of the following actions: (1) storing an updated state of the contents being edited by the user through a hotkey, (2) recording the name of system program and the path of program execution file, and (3) shooting the contents of a user interface through a screen shot process (such as a window of Windows application).

The above processing procedure can display the user interfaces of the programs currently being executed one by one by way of programming and set the user interfaces as active windows. Then, the process name of the program being executed and the path of program execution file can be obtained through an application interface (API) and can be stored in a pre-defined table 700. Then, when the operating system 101 is started up again, the system program and the path of program execution file can be executed and recovered through a comparison with the pre-defined table.

Referring to FIG. 7, a schematic diagram of a pre-defined table 700 is shown. When the application used by the user is a word editing program such as WinWord.exe, PowerPNT.exe or Notepad.exe, the operating system 101 can store the most updated state of the contents being edited by the user. When the application used by the user is a website program such as Chrome.exe or Msedge.exe, the operating system 101 can record the process name of the program and the path of program execution file. When the application used by the user is a mail program such as OUTLOOK.exe, the operating system 101 can shoot the contents of the user interface (such as a window of Windows application) and store them at a fixed path for subsequent recovery and execution of programs. The process name and the path of program execution file are illustrated in a table as below.

| Process name | Path of program execution file |
|---|---|
| WinWord.exe | C:\Program Files\Microsoft Office\ |
| | Office15\WinWord.exe |
| Chrome.exe | C:\Program |
| | Files\Google\Chrome\Application\Chrome.exe |
| OUTLOOK.exe | C:\Program Files\Microsoft Office\ |
| | Office15\OUTLOOK.exe |

After the operating system 101 is started up again, the operating system 101 will execute programs according to the contents of screen shot, open relevant contents of screen shot, and display the files stored at a fixed path on the screen lid 103. When this action is performed, whether the corresponding contents of screen shot contain privacy information is checked through comparison. For instance, whether the corresponding contents of screen shot contain privacy information can be determined through an AI training model in advance. If the contents of screen shot are found to contain privacy information, then inquiry is made through alert dialog to confirm whether the operating system 101 needs recovery and program execution.

According to the device and the method for processing an abnormal sleep state of an operating system disclosed in the above embodiments of the present invention, a mechanism for reminding the user of an abnormal sleep state is created; when battery power capacity is lower than a certain power capacity, the current state of the operating system is recorded; when the operating system is restarted in the wake of abnormality, the work state is recovered with the screen shot data. Thus, the present invention can avoid an electronic device being abnormally shutdown due to the depletion of power capacity and through system recovery, the device can recover to the work state before the operating system enters a sleep mode, so that the user's workload can be reduced.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A device for processing an abnormal sleep state of an operating system, comprising:
a detection unit;
an abnormal event determination unit;
an event information verification unit; and
an abnormality notification unit,
wherein the detection unit is used for detecting whether a screen lid closing event occurs, the operating system is preset to enter a sleep mode when a screen lid is closed, and the operating system is preset to enter a wake-up mode when the screen lid is opened;
the abnormal event determination unit is used for determining whether the screen lid is closed and whether an event that the operating system is not entering the sleep mode occurs;
the event information verification unit is used for verifying an event information and determining whether the event is classified as an abnormal event according to the event information;
the abnormality notification unit is used for sending an abnormality notification to a system administrator unit, which performs a processing according to a power status of the operating system.

2. The processing device according to claim 1, wherein the determination of the event comprises determining whether the power status of the operating system matches a preset power status when the screen lid is closed.

3. The processing device according to claim 1, wherein the verification of the event information comprises analyzing and verifying an event that the operating system is entering the sleep mode as recorded in a system event detector.

4. The processing device according to claim 1, wherein the verification of the event information comprises determining, after the screen lid closing event is triggered, whether a normal wake-up event is recorded in a waked-up event list.

5. The processing device according to claim 4, wherein the normal wake-up event comprises remotely waking up the operating system.

6. The processing device according to claim 1, wherein the abnormality notification comprises adjusting a setting of the operating system to set a power planning option to a power-saving mode.

7. The processing device according to claim 1, wherein the abnormality notification comprises notifying the user by using a buzzer as sound reminder, using a screen flash as visual reminder or a combination thereof.

8. The processing device according to claim 7, wherein the processing device determines a level of at least one of actions that the buzzer is used as sound reminder and the screen flash is used as a visual reminder according to a remaining capacity of a system power.

9. The processing device according to claim 1, wherein when a remaining capacity of a system power is lower than a certain power capacity, the processing device performs the processing comprising at least one of the following actions: (1) storing an updated state of contents being edited by the user through a hotkey, (2) recording a name of a system program and a path of a program execution file, and (3) shooting contents of a user interface through a screen shot process.

10. A method for processing an abnormal sleep state of an operating system, comprising:
enabling an operating system and continuously supplying a system power, wherein the operating system is preset to enter a sleep mode when a screen lid is closed, and the operating system is preset to enter a wake-up mode when the screen lid is opened;
detecting whether a screen lid closing event occurs and determining whether the screen lid is closed and whether an event that the operating system is not entering the sleep mode occurs;
verifying an event information and determining whether the event is classified as an abnormal event according to the event information; and
sending an abnormality notification to a system administrator unit for performing a processing according to a power status of the operating system.

11. The processing method according to claim 10, wherein the determination of the event comprises determining whether the power status of the operating system matches a preset power status when the screen lid is closed.

12. The processing method according to claim 10, wherein the verification of the event information comprises analyzing and verifying an event that the operating system is entering the sleep mode as recorded in a system event detector.

13. The processing method according to claim 10, wherein the verification of the event information comprises determining, after the screen lid closing event is triggered, whether a normal wake-up event is recorded in a waked-up event list.

14. The processing method according to claim 13, wherein the normal wake-up event comprises remotely waking up the operating system.

15. The processing method according to claim 10, wherein the abnormality notification comprises adjusting a setting of the operating system and setting a power planning option to a power-saving mode.

16. The processing method according to claim 10, wherein the abnormality notification comprises notifying the user by using a buzzer as sound reminder, using a screen flash as visual reminder or a combination thereof.

17. The processing method according to claim 16, wherein a level of at least one of actions that the buzzer is used as sound reminder and the screen flash is used as a visual reminder is determined according to a remaining capacity of a system power.

18. The processing method according to claim 10, wherein when a remaining capacity of a system power is lower than a certain power capacity, performing the processing comprises at least one of the following actions: (1) storing an updated state of contents being edited by the user through a hotkey, (2) recording a name of a system program and a path of a program execution file, and (3) shooting contents of a user interface through a screen shot process.
